(19) United States
(12) Patent Application Publication
(10) Pub. No.: US 2026/0175318 A1
(43) Pub. Date: Jun. 25, 2026

(54) VEHICLE-MOUNTED HIGH-ENERGY LASER-INDUCED ROCK FRACTURING CONTROL SYSTEM AND METHOD

(71) Applicants: SHENZHEN UNIVERSITY, SHENZHEN (CN); SICHUAN UNIVERSITY, CHENGDU (CN)

(72) Inventors: MINGZHONG GAO, SHENZHEN (CN); JUNJUN LIU, SHENZHEN (CN); HAICHUN HAO, SHENZHEN (CN); JING XIE, SHENZHEN (CN); LIJUAN ZHAO, SHENZHEN (CN); BENGAO YANG, SHENZHEN (CN); XUEMIN ZHOU, SHENZHEN (CN); LEI YANG, SHENZHEN (CN); RUIFENG TANG, SHENZHEN (CN); YANBO BAI, SHENZHEN (CN); YANG ZHANG, SHENZHEN (CN)

(21) Appl. No.: 19/539,938

(22) Filed: Feb. 13, 2026

Related U.S. Application Data
(63) Continuation of application No. PCT/CN2025/108792, filed on Jul. 16, 2025.

(30) Foreign Application Priority Data
Oct. 23, 2024 (CN) 202411481709.8

(51) Int. Cl. B23K 26/03; B23K 26/062

(52) U.S. Cl. CPC B23K 26/03; B23K 26/0626

(57) ABSTRACT

Disclosed is a vehicle-mounted high-energy laser-induced rock fracturing control system and method. The method includes: acquiring, by a second image acquisition and analysis unit, surrounding environment information of an electric flat cart; generating, by an electric flat cart control unit, a first control command; controlling the electric flat cart to move to a designated rock crushing position; acquiring, by a first image acquisition and analysis unit, the type of the rock to be crushed, and acquiring real-time condition information of laser-induced rock fracturing after activating a laser emission unit; acquiring, by a laser control unit, a laser emission parameter corresponding to the current type of rock to be crushed, adjusting the laser emission parameter, and generating a second control command according to the laser emission parameter; and controlling the laser emission unit to activate to emit a laser to fracture the rock.

### TECHNICAL FIELD

The present disclosure belongs to the technical field of high-efficiency hard rock crushing and proposes a vehicle-mounted high-energy laser-induced rock fracturing control system and method.

### BACKGROUND

With the continuous increase in the occurrence depth of resource exploitation, hydropower projects and transportation projects, the rock strength is also increased continuously. The increase in rock strength has greatly raised the difficulty of rock crushing and excavation, reduced the efficiency of rock crushing, and accelerated the wear of mechanical cutters, thus leading to a significant extension of the cycle and a substantial increase in the cost for crushing and excavating deep hard rock.

Moreover, most of the current rock crushing schemes involve operators driving rock crushing vehicles to designated positions and completing rock crushing work by means of rock crushing devices based on survey data and previous rock crushing experience. Due to different rock types, operators' experience also varies from person to person, resulting in an unsatisfactory rock crushing effect. Furthermore, existing rock crushing schemes pay little attention to the evolutionary state of rock during the rock crushing process, which may lead to the interruption of rock crushing work.

Therefore, to improve the deep hard rock crushing efficiency, there is an urgent need for a novel and high-efficiency rock crushing scheme.

### SUMMARY

An objective of the present disclosure is to provide a vehicle-mounted high-energy laser-induced rock fracturing control system and method, which can automatically complete the entire rock crushing process and greatly improve the rock crushing efficiency.

To solve the technical problem, the present disclosure adopts the following technical solutions:
In an aspect, the present disclosure provides a vehicle-mounted high-energy laser-induced rock fracturing control system, including:
an electric flat cart, configured to be controlled to move to a designated rock crushing position after receiving a first control command of an electric flat cart control unit;
the electric flat cart control unit, disposed on the electric flat cart, storing a motion path of the electric flat cart, and configured to generate the first control command according to the stored motion path and the surrounding environment information of the electric flat cart acquired by the second image acquisition and analysis unit;
a laser emission unit, disposed at a front end of a mechanical arm, mounted on the electric flat cart via the mechanical arm, and configured to activate to emit a laser to fracture the rock after receiving a second control command of the laser control unit;
a laser control unit, disposed on the electric flat cart, storing a laser emission parameter corresponding to the type of the rock to be crushed, configured to acquire the laser emission parameter corresponding to the current type of rock to be crushed after receiving the type of the rock to be crushed acquired by the first image acquisition and analysis unit, adjust the laser emission parameter after receiving the real-time condition information of laser-induced rock fracturing acquired by the first image acquisition and analysis unit, and generate the second control command according to the laser emission parameter;
the first image acquisition and analysis unit, disposed on the electric flat cart, and configured to acquire the type of the rock to be crushed after the electric flat cart moves to the designated rock crushing position, acquire the real-time condition information of laser-induced rock fracturing after the laser emission unit is activated, and send the real-time condition information of laser-induced rock fracturing to the laser control unit; and
the second image acquisition and analysis unit, disposed on the electric flat cart and configured to acquire the surrounding environment information of the electric flat cart in the moving process and send the surrounding environment information to the electric flat cart control unit.

As a further optimization, the vehicle-mounted high-energy laser-induced rock fracturing control system further includes a mechanical arm control unit, disposed on the electric flat cart;
after the electric flat cart moves to the designated rock crushing position, the electric flat cart control unit notifies the mechanical arm control unit;
the mechanical arm control unit is configured to generate a third control command based on the position of the rock to be crushed acquired by the first image acquisition and analysis unit after receiving the notification of the electric flat cart control unit, and control the mechanical arm to adjust to a predetermined height and a predetermined attitude after the mechanical arm receives the third control command; and
after the mechanical arm is adjusted to the predetermined height and the predetermined attitude, the mechanical arm control unit notifies the laser control unit, and the laser control unit sends the generated second control command to the laser emission unit after receiving the notification of the mechanical arm control unit.

As a further optimization, the electric flat cart is further provided with a position sensor;
the second image acquisition and analysis unit is activated after the electric flat cart receives the first control command and before the electric flat cart moves, and acquires the surrounding environment information in real time in the moving process of the electric flat cart;
when the second image acquisition and analysis unit is activated, the position sensor acquires the current position of the electric flat cart and determines whether the electric flat cart is located at a starting point of the motion path, where if the electric flat cart is located at the starting point of the motion path, the electric flat cart moves according to the motion path;
in the moving process of the electric flat cart, the second image acquisition and analysis unit acquires the surrounding environment information in real time, and determines whether the motion path is to be optimized based on the surrounding environment information, where if the motion path is to be optimized, the electric flat cart control unit is notified to control the electric flat cart to move to the designated rock crushing position according to the optimized motion path; and
when the electric flat cart moves to the designated rock crushing position, the electric flat cart control unit notifies the second image acquisition and analysis unit to shut down, and the electric flat cart control unit notifies the first image acquisition and analysis unit to activate.

As a further optimization, the determining whether the motion path is to be optimized based on the surrounding environment information refers to:
acquiring ground depression degree information, slope information and obstacle information in front of the electric flat cart in the motion path according to the acquired surrounding environment information, where when the ground depression degree is lower than a preset depression degree, the slope is lower than a preset slope, no obstacle is present, and an obstacle is present and a size of the obstacle is smaller than a specified size, the motion path is not optimized, and otherwise, the motion path is optimized.

As a further optimization, after being activated, the first image acquisition and analysis unit acquires image information of the rock to be crushed, determines the type and position of the current rock to be crushed based on the image information, notifies the type of the rock to be crushed to the laser control unit, and notifies the position of the rock to be crushed to the mechanical arm control unit.

As a further optimization, after receiving the notification of the first image acquisition and analysis unit, the mechanical arm control unit determines whether the maximum height of the mechanical arm is capable of reaching the height of the rock to be crushed based on the position of the rock to be crushed, and if the maximum height of the mechanical arm is capable of reaching the height of the rock to be crushed, the mechanical arm control unit controls the mechanical arm to be adjusted to the predetermined height and the predetermined attitude.

As a further optimization, the electric flat cart is further provided with a lifting platform, and a bottom surface of the mechanical arm is fixed to a surface of the lifting platform; and
when the maximum height of the mechanical arm is incapable of reaching the height of the rock to be crushed, the mechanical arm control unit notifies the electric flat cart control unit, the electric flat cart control unit calculates a difference value between the height of the rock to be crushed and the maximum height of the mechanical arm and raises the lifting platform according to the difference value, such that the mechanical arm is capable of reaching the predetermined height and the mechanical arm is controlled to be adjusted to the predetermined height and the predetermined attitude.

As a further optimization, the laser emission parameter corresponding to the type of the rock to be crushed includes laser spot size, laser irradiation power and laser irradiation time; and
the adjusting the laser emission parameter refers to:
acquiring image information of laser-induced rock fracturing via the first image acquisition and analysis unit, acquiring crack area information, opening degree information and length information based on the image information, and taking the crack area information, opening degree information and length information as the real-time condition information; and
in a laser irradiation process at the position of the current rock to be crushed, determining whether the type of the rock changes in real time, where if the type of the rock does not change, determining whether the crack area information, opening degree information and length information correspond to the predetermined crack area information, predetermined opening degree information and predetermined length information, and if the crack area information, opening degree information and length information do not correspond to the predetermined crack area information, predetermined opening degree information and predetermined length information, instructing the laser control unit to linearly increase or decrease the laser spot size, the laser irradiation power and the laser irradiation time until the crack area information, the opening degree information and the length information correspond to the predetermined crack area information, predetermined opening degree information and predetermined length information.

As a further optimization, in the laser irradiation process at the position of the current rock to be crushed, if the type of the rock remains unchanged, after the laser irradiation time reaches a predetermined time or it is determined that the rock reaches a predetermined rock fracturing state based on the crack area information, the opening degree information and the length information, the first image acquisition and analysis unit notifies the laser control unit to be shut down and notifies the mechanical arm control unit to adjust the mechanical arm to the next position of the rock to be crushed; and
in the laser irradiation process at the position of the current rock to be crushed, if the type of the rock is changed, the image information of the changed rock is sent to a remote management control center, and the remote management control center determines whether the laser irradiation process at the position of the current rock to be crushed is to be continued.

In another aspect, the present disclosure further provides a vehicle-mounted high-energy laser-induced rock fracturing control method, applied to the vehicle-mounted high-energy laser-induced rock fracturing control system, including the following steps:
disposing the electric flat cart control unit, the laser control unit, the first image acquisition and analysis unit and the second image acquisition and analysis unit on the electric flat cart, and disposing the laser emission unit on the electric flat cart via the mechanical arm;
acquiring, by the second image acquisition and analysis unit, the surrounding environment information in the moving process of the electric flat cart, and sending the surrounding environment information to the electric flat cart control unit;
generating, by the electric flat cart control unit, the first control command according to the stored motion path of the electric flat cart and the surrounding environment information acquired by the second image acquisition and analysis unit;
after receiving the first control command of the electric flat cart control unit, controlling the electric flat cart to move to the designated rock crushing position;
after the electric flat cart moves to the designated rock crushing position, acquiring, by the first image acquisition and analysis unit, the type of the rock to be crushed, acquiring the real-time condition information of laser-induced rock fracturing after the laser emission unit is activated, and sending the real-time condition information to the laser control unit;
after receiving the type of the rock to be crushed acquired by the first image acquisition and analysis unit, acquiring, by the laser control unit, the laser emission parameter corresponding to the type of current rock to be crushed, after receiving the real-time condition information of laser-induced rock fracturing acquired by the first image acquisition and analysis unit, adjusting the laser emission parameter, and generating the second control command according to the laser emission parameter; and
after receiving the second control command of the laser control unit, controlling the laser emission unit to activate to emit a laser to fracture the rock.

The present disclosure has the following beneficial effects: through the above vehicle-mounted high-energy laser-induced rock fracturing control system and method, first, the electric flat cart control unit, the laser control unit, the first image acquisition and analysis unit, and the second image acquisition and analysis unit are disposed on the electric flat cart, and the laser emission unit is disposed on the electric flat cart via the mechanical arm, thus, completing hardware configuration work for the entire rock crushing work; second, the second image acquisition and analysis unit acquires the surrounding environment information of the electric flat cart in the moving process and sends the surrounding environment information to the electric flat cart control unit, the electric flat cart control unit generates the first control command according to the stored motion path of the electric flat cart and the surrounding environment information acquired by the second image acquisition and analysis unit, and after receiving the first control command of the electric flat cart control unit, the electric flat cart is controlled to move to the designated rock crushing position, such that the electric flat cart can accomplish the automatic driving operation along the set moving path according to the actual condition of the rock crushing site and also can optimize the moving path according to on-site sudden working conditions.

After the electric flat cart moves to the designated rock crushing position, the first image acquisition and analysis unit acquires the type of the rock to be crushed, acquires the real-time condition information of laser-induced rock fracturing after the laser emission unit is activated, and sends the real-time condition information to the laser control unit. After receiving the type of the rock to be crushed acquired by the first image acquisition and analysis unit, the laser control unit acquires the laser emission parameter corresponding to the type of current rock to be crushed, adjusts the laser emission parameter after receiving the real-time condition information of laser-induced rock fracturing acquired by the first image acquisition and analysis unit, and generates the second control command according to the laser emission parameter; and after receiving the second control command of the laser control unit, the laser emission unit is controlled to activate to emit a laser to crush the rock. Therefore, the laser emission parameter can be automatically adjusted according to the type of the rock to be crushed and the evolutionary state of rock during the rock crushing process by virtue of the first image acquisition and analysis unit, thereby automatically completing the entire laser rock crushing work.

### BRIEF DESCRIPTION OF THE DRAWINGS

FIG. 1 is a flowchart of a vehicle-mounted high-energy laser-induced rock fracturing control method in Embodiment 2 of the present disclosure.

### DETAILED DESCRIPTION OF THE EMBODIMENTS

To make the objectives, technical solutions, and advantages of the embodiments of the present disclosure clearer, the technical solutions in the embodiments of the present disclosure will be clearly and completely described below in conjunction with the accompanying drawings in the embodiments of the present disclosure. Apparently, the described embodiments are a part of embodiments of the present disclosure, rather than all the embodiments. The components of the embodiments of the present disclosure described and illustrated in the accompanying drawings herein may be arranged and designed in various different configurations.

### Embodiment 1

This embodiment provides a vehicle-mounted high-energy laser-induced rock fracturing control system, which consists of the following parts:
an electric flat cart, configured to be controlled to move to a designated rock crushing position after receiving a first control command of an electric flat cart control unit;
the electric flat cart control unit, disposed on the electric flat cart, storing a motion path of the electric flat cart, and configured to generate the first control command according to the stored motion path and the surrounding environment information of the electric flat cart acquired by the second image acquisition and analysis unit;
a laser emission unit, disposed at a front end of a mechanical arm, mounted on the electric flat cart via the mechanical arm, and configured to activate to emit a laser to fracture the rock after receiving a second control command of the laser control unit;
a laser control unit, disposed on the electric flat cart, storing a laser emission parameter corresponding to the type of the rock to be crushed, configured to acquire the laser emission parameter corresponding to the current type of rock to be crushed after receiving the type of the rock to be crushed acquired by the first image acquisition and analysis unit, adjust the laser emission parameter after receiving the real-time condition information of laser-induced rock fracturing acquired by the first image acquisition and analysis unit, and generate the second control command according to the laser emission parameter;
the first image acquisition and analysis unit, disposed on the electric flat cart, and configured to acquire the type of the rock to be crushed after the electric flat cart moves to the designated rock crushing position, acquire the real-time condition information of laser-induced rock fracturing after the laser emission unit is activated, and send the real-time condition information of laser-induced rock fracturing to the laser control unit; and
the second image acquisition and analysis unit, disposed on the electric flat cart and configured to acquire the surrounding environment information of the electric flat cart in the moving process and send the surrounding environment information to the electric flat cart control unit.

In the above system, first, the second image acquisition and analysis unit can be used to assist the electric flat cart to automatically drive to the designated rock crushing position; second, after the electric flat cart arrives at the designated rock crushing position, the type of the rock to be crushed can be acquired by virtue of the first image acquisition and analysis unit to obtain the initial laser emission parameter. In the rock crushing process, the real-time condition information of laser-induced rock fracturing is acquired similarly by virtue of the first image acquisition and analysis unit to adjust the laser emission parameter, such that the rock crushing accuracy can also be ensured while the entire rock crushing work can be automatically completed.

It should be noted that before the laser is emitted, the height and attitude of the mechanical arm are still in an initial state. Due to different rock crushing positions and different types and heights of the rock to be crushed, after the electric flat cart moves to the rock crushing designed position, the height and attitude of the mechanical arm need to be adjusted according to actual rock crushing demands to conduct subsequent rock crushing work. Therefore, control of the mechanical arm also requires the corresponding control unit to complete the adjustment work of the mechanical arm before the laser is emitted. Therefore, the vehicle-mounted high-energy laser-induced rock fracturing control system in this embodiment further needs to include the mechanical arm control unit, where the mechanical arm control unit is disposed on the electric flat cart.

Here, after the electric flat cart moves to the designated rock crushing position, the electric flat cart control unit notifies the mechanical arm control unit; the mechanical arm control unit is configured to generate a third control command based on the position of the rock to be crushed acquired by the first image acquisition and analysis unit after receiving the notification of the electric flat cart control unit, and control the mechanical arm to be adjusted to a predetermined height and a predetermined attitude after the mechanical arm receives the third control command; and after the mechanical arm is adjusted to the predetermined height and the predetermined attitude, the mechanical arm control unit notifies the laser control unit, and the laser control unit sends the generated second control command to the laser emission unit after receiving the notification of the mechanical arm control unit.

It should be noted that since the electric flat cart needs to automatically drive to the designated rock crushing position to work according to the actual working condition of the rock crushing site in this embodiment, and the electric flat cart may not be located at the initial position of the motion path, to control the initial position of the electric flat cart that precisely arrives at the motion path, the position information of the electric flat cart needs to be sensed. Meanwhile, since the second image acquisition and analysis unit can sense the surrounding environment information, after the electric flat cart arrives at the starting point of the motion path, the motion path can be optimized via the surrounding environment information. Therefore, in this embodiment, the electric flat cart can also be provided with a position sensor. The second image acquisition and analysis unit is activated after the electric flat cart receives the first control command and before the electric flat cart moves, and acquires the surrounding environment information in real time in the moving process of the electric flat cart; and when the second image acquisition and analysis unit is activated, the position sensor acquires the current position of the electric flat cart and determines whether the electric flat cart is located at a starting point of the motion path, where if the electric flat cart is located at the starting point of the motion path, the electric flat cart moves according to the motion path.

Here, in the moving process of the electric flat cart, the second image acquisition and analysis unit acquires the surrounding environment information in real time, and determines whether the motion path is to be optimized based on the surrounding environment information, where if the motion path is to be optimized, the electric flat cart control unit is notified to control the electric flat cart to move to the designated rock crushing position according to the optimized motion path; and when the electric flat cart moves to the designated rock crushing position, the electric flat cart control unit notifies the second image acquisition and analysis unit to shut down, and the electric flat cart control unit notifies the first image acquisition and analysis unit to activate.

Certainly, if the electric flat cart itself is located at the starting point of the moving path, and it is determined that optimization of the motion path is not needed according to the surrounding environment information, the electric flat cart will automatically complete automatic driving work of driving to the designated rock crushing position according to the initial motion path. However, the actual working conditions at rock crushing sites are complex and variable, and the motion path needs to be optimized in most cases. Moreover, the first image acquisition and analysis unit can be shut down after the electric flat cart arrives at the designated rock crushing position, to save the system energy efficiency and prolong the service life thereof.

Specifically, in this embodiment, a determination condition for optimizing the motion path generally needs to take into account the ground depression degree, the slope, the presence or absence of obstacles, the size of obstacles when present, and the like during the traveling process of the electric flat cart. In this embodiment, the determining whether the motion path is to be optimized based on the surrounding environment information refers to:
acquiring ground depression degree information, slope information and obstacle information in front of the electric flat cart in the motion path according to the acquired surrounding environment information, where when the ground depression degree is lower than a preset depression degree, the slope is lower than a preset slope, no obstacle is present, and an obstacle is present and a size of the obstacle is smaller than a specified size, the motion path is not optimized, and otherwise, the motion path is optimized.

Here, when considering whether to optimize the motion path, unless the depression degree is excessively large, the slope is excessively large, or the obstacle is excessively large when the obstacle is present, since the electric flat cart is usually heavy, to save the energy consumption of the electric flat cart, it is necessary to guarantee that the increased travel distance of the motion path is not excessively long. Therefore, in this case, the travel distance of the original motion path can be acquired and then the optimized travel distance is acquired, and the difference between the latter and the former does not exceed a predetermined difference value.

It should be noted that since the laser emission parameter corresponds to the type of the rock to be crushed, and the electric flat cart cannot directly activate the laser emission unit to crush the rock after arriving at the designated rock crushing position, it is also necessary to adjust the mechanical arm. Therefore, in this embodiment, after being activated, the first image acquisition and analysis unit acquires image information of the rock to be crushed, determines the type and position of the current rock to be crushed based on the image information, notifies the type of the rock to be crushed to the laser control unit, and notifies the position of the rock to be crushed to the mechanical arm control unit.

In general, the height and attitude of the mechanical arm can be adjusted. The attitude adjustment can generally adapt to the requirements of most rock crushing sites. However, since the height of the rock to be crushed is unknown, there is a case where the maximum height of the mechanical arm does not reach the position of the rock to be crushed. In this case, even if the mechanical arm is adjusted to the maximum height, and the laser emission unit is activated for laser rock crushing, the rock crushing work will most likely not be completed. Therefore, in this embodiment, a lifting platform can be provided for the electric flat cart to complete the adjustment work of the mechanical arm. Therefore, in this embodiment, after the mechanical arm control unit receives the notification of the first image acquisition and analysis unit, whether the maximum height of the mechanical arm can reach the height of the rock to be crushed is determined based on the position of the rock to be crushed. When the maximum height of the mechanical arm can reach the height of the rock to be crushed, the mechanical arm is controlled to the predetermined height and the predetermined attitude.

Therefore, in this embodiment, the electric flat cart is further provided with a lifting platform, and a bottom surface of the mechanical arm is fixed to a surface of the lifting platform;
when the maximum height of the mechanical arm is incapable of reaching the height of the rock to be crushed, the mechanical arm control unit notifies the electric flat cart control unit, the electric flat cart control unit calculates a difference value between the height of the rock to be crushed and the maximum height of the mechanical arm and raises the lifting platform according to the difference value, such that the mechanical arm is capable of reaching the predetermined height and the mechanical arm is controlled to be adjusted to the predetermined height and the predetermined attitude.

After the mechanical arm is adjusted completely, the corresponding laser emission parameter can be matched according to the type of the rock to be crushed. In general, for different types of rocks, the laser spot size, the laser irradiation power, and the laser irradiation time of the laser emission unit directly affect the rock crushing effect and the rock crushing efficiency. Therefore, in this embodiment, the laser emission parameter corresponding to the type of the rock to be crushed should at least include the laser spot size, the laser irradiation power, and the laser irradiation time.

Since the evolutionary state of the rock in the rock crushing process will be monitored all the time by means of the first image acquisition and analysis unit, in the rock crushing process, it may be necessary to adjust the above laser emission parameter to better complete the rock crushing work. Therefore, in this embodiment, the adjusting the laser emission parameter can refer to:
acquiring image information of laser-induced rock fracturing via the first image acquisition and analysis unit, acquiring crack area information, opening degree information and length information based on the image information, and taking the crack area information, opening degree information and length information as the real-time condition information; and
in a laser irradiation process at the position of the current rock to be crushed, determining whether the type of the rock changes in real time, where if the type of the rock does not change, determining whether the crack area information, opening degree information and length information correspond to the predetermined crack area information, predetermined opening degree information and predetermined length information, and if the crack area information, the opening degree information and the length information do not correspond to the predetermined crack area information, predetermined opening degree information and predetermined length information, instructing the laser control unit to linearly increase or decrease the laser spot size, the laser irradiation power and the laser irradiation time until the crack area information, the opening degree information and the length information correspond to the predetermined crack area information, the predetermined opening degree information and the predetermined length information.

It should be noted that in this embodiment, in a laser irradiation process at the position of the current rock to be crushed, if the type of the rock does not change, after the laser irradiation time reaches a predetermined time or it is determined that the rock reaches a predetermined rock fracturing state based on the crack area information, the opening degree information and the length information, the first image acquisition and analysis unit notifies the laser control unit to shut down and notifies the mechanical arm control unit to adjust the mechanical arm to the next position of the rock to be crushed; and
in the laser irradiation process at the position of the current rock to be crushed, if the type of the rock is changed, the image information of the changed rock is sent to a remote management control center, and the remote management control center determines whether the laser irradiation process at the position of the current rock to be crushed is to be continued.

Here, operating personnel of the remote management control center will manually determine whether the subsequent laser irradiation process is to be continued according to the image information of the rock when the type of the rock changes, and whether it is necessary to adjust the laser emission parameter, the height and position of the mechanical arm, and the like when the subsequent laser irradiation process is to be continued. When adjustment is needed, it is only necessary to send related control commands to the mechanical arm control unit or the laser emission unit.

### Embodiment 2

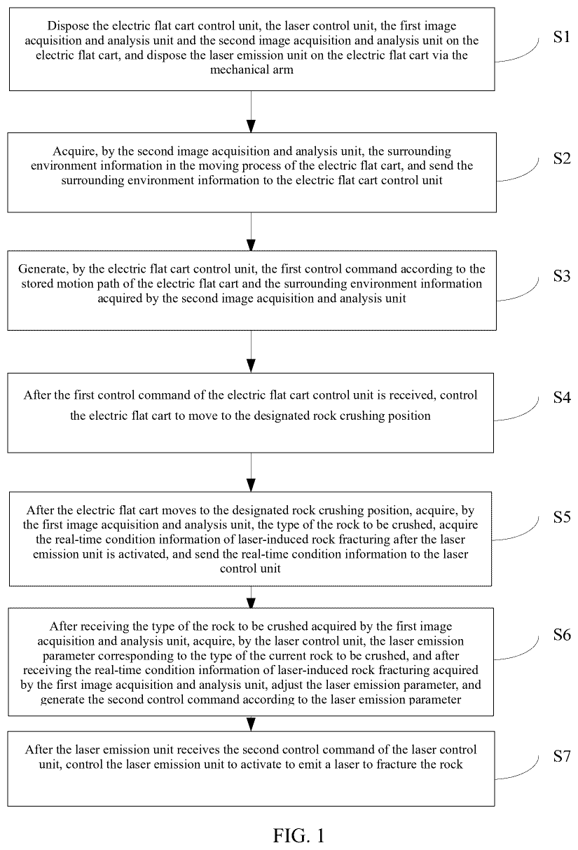

On the basis of Embodiment 1, this embodiment provides a vehicle-mounted high-energy laser-induced rock fracturing control method, a flowchart of which is shown in FIG. 1. This method includes the following steps:
S1, the electric flat cart control unit, the laser control unit, the first image acquisition and analysis unit and the second image acquisition and analysis unit are disposed on the electric flat cart, and the laser emission unit is disposed on the electric flat cart via the mechanical arm;
S2, the second image acquisition and analysis unit acquires the surrounding environment information in the moving process of the electric flat cart, and sends the surrounding environment information to the electric flat cart control unit;
S3, the electric flat cart control unit generates the first control command according to the stored motion path of the electric flat cart and the surrounding environment information acquired by the second image acquisition and analysis unit;
S4, after the first control command of the electric flat cart control unit is received, the electric flat cart is controlled to move to the designated rock crushing position;
S5, after the electric flat cart moves to the designated rock crushing position, the first image acquisition and analysis unit acquires the type of the rock to be crushed, acquires the real-time condition information of laser-induced rock fracturing after the laser emission unit is activated, and sends the real-time condition information to the laser control unit;
S6, after receiving the type of the rock to be crushed acquired by the first image acquisition and analysis unit, the laser control unit acquires the laser emission parameter corresponding to the type of the current rock to be crushed, and after receiving the real-time condition information of laser-induced rock fracturing acquired by the first image acquisition and analysis unit, adjusts the laser emission parameter, and generates the second control command according to the laser emission parameter; and
S7, after the laser emission unit receives the second control command of the laser control unit, the laser emission unit is controlled to activate to emit a laser to fracture the rock.

It can be known from the description in Embodiment 1 that the application scenario and realization principle of this embodiment are identical to those of Embodiment 1, which are not repeatedly described.

The above descriptions merely represent preferred embodiments of the present disclosure and are not intended to limit the scope of the present disclosure. Various modifications and adaptations may be made by those skilled in the art without departing from the spirit of the present disclosure. Any modification, equivalent replacement or improvement made within the spirit and principle of the present disclosure shall fall within the protection scope of the present disclosure.

1. A vehicle-mounted high-energy laser-induced rock fracturing control system, comprising:
an electric flat cart, configured to be controlled to move to a designated rock crushing position after receiving a first control command of an electric flat cart control unit;
the electric flat cart control unit, disposed on the electric flat cart, storing a motion path of the electric flat cart, and configured to generate the first control command according to the stored motion path and the surrounding environment information of the electric flat cart acquired by the second image acquisition and analysis unit;
a laser emission unit, disposed at a front end of a mechanical arm, mounted on the electric flat cart via the mechanical arm, and configured to activate to emit a laser to fracture the rock after receiving a second control command of the laser control unit;
a laser control unit, disposed on the electric flat cart, storing a laser emission parameter corresponding to the type of the rock to be crushed, configured to acquire the laser emission parameter corresponding to the current type of rock to be crushed after receiving the type of the rock to be crushed acquired by the first image acquisition and analysis unit, adjust the laser emission parameter after receiving the real-time condition information of laser-induced rock fracturing acquired by the first image acquisition and analysis unit, and generate the second control command according to the laser emission parameter;
the first image acquisition and analysis unit, disposed on the electric flat cart, and configured to acquire the type of the rock to be crushed after the electric flat cart moves to the designated rock crushing position, acquire the real-time condition information of laser-induced rock fracturing after the laser emission unit is activated, and send the real-time condition information of laser-induced rock fracturing to the laser control unit; and
the second image acquisition and analysis unit, disposed on the electric flat cart and configured to acquire the surrounding environment information of the electric flat cart in the moving process and send the surrounding environment information to the electric flat cart control unit.

2. The vehicle-mounted high-energy laser-induced rock fracturing control system according to claim 1, further comprising a mechanical arm control unit, disposed on the electric flat cart, wherein
after the electric flat cart moves to the designated rock crushing position, the electric flat cart control unit notifies the mechanical arm control unit;
the mechanical arm control unit is configured to generate a third control command based on the position of the rock to be crushed acquired by the first image acquisition and analysis unit after receiving the notification of the electric flat cart control unit, and control the mechanical arm to be adjusted to a predetermined height and a predetermined attitude after the mechanical arm receives the third control command; and
after the mechanical arm is adjusted to the predetermined height and the predetermined attitude, the mechanical arm control unit notifies the laser control unit, and the laser control unit sends the generated second control command to the laser emission unit after receiving the notification of the mechanical arm control unit.

3. The vehicle-mounted high-energy laser-induced rock fracturing control system according to claim 1, wherein the electric flat cart is further provided with a position sensor;
the second image acquisition and analysis unit is activated after the electric flat cart receives the first control command and before the electric flat cart moves, and acquires the surrounding environment information in real time in the moving process of the electric flat cart;
when the second image acquisition and analysis unit is activated, the position sensor acquires the current position of the electric flat cart and determines whether the electric flat cart is located at a starting point of the motion path, wherein if the electric flat cart is located at the starting point of the motion path, the electric flat cart moves according to the motion path;
in the moving process of the electric flat cart, the second image acquisition and analysis unit acquires the surrounding environment information in real time, and determines whether the motion path is to be optimized based on the surrounding environment information, wherein if the motion path is to be optimized, the electric flat cart control unit is notified to control the electric flat cart to move to the designated rock crushing position according to the optimized motion path; and
when the electric flat cart moves to the designated rock crushing position, the electric flat cart control unit notifies the second image acquisition and analysis unit to shut down, and the electric flat cart control unit notifies the first image acquisition and analysis unit to activate.

4. The vehicle-mounted high-energy laser-induced rock fracturing control system according to claim 3, wherein the determining whether the motion path is to be optimized based on the surrounding environment information refers to:
acquiring ground depression degree information, slope information and obstacle information in front of the electric flat cart in the motion path according to the acquired surrounding environment information, wherein when the ground depression degree is lower than a preset depression degree, the slope is lower than a preset slope, no obstacle is present, and an obstacle is present and a size of the obstacle is smaller than a specified size, the motion path is not optimized, and otherwise, the motion path is optimized.

5. The vehicle-mounted high-energy laser-induced rock fracturing control system according to claim 2, wherein after being activated, the first image acquisition and analysis unit acquires image information of the rock to be crushed, determines the type and position of the current rock to be crushed based on the image information, notifies the type of the rock to be crushed to the laser control unit, and notifies the position of the rock to be crushed to the mechanical arm control unit.

6. The vehicle-mounted high-energy laser-induced rock fracturing control system according to claim 5, wherein after receiving the notification of the first image acquisition and analysis unit, the mechanical arm control unit determines whether the maximum height of the mechanical arm is capable of reaching the height of the rock to be crushed based on the position of the rock to be crushed, and if the maximum height of the mechanical arm is capable of reaching the height of the rock to be crushed, the mechanical arm control unit controls the mechanical arm to be adjusted to the predetermined height and the predetermined attitude.

7. The vehicle-mounted high-energy laser-induced rock fracturing control system according to claim 6, wherein the electric flat cart is further provided with a lifting platform, and a bottom surface of the mechanical arm is fixed to a surface of the lifting platform; and
when the maximum height of the mechanical arm is incapable of reaching the height of the rock to be crushed, the mechanical arm control unit notifies the electric flat cart control unit, the electric flat cart control unit calculates a difference value between the height of the rock to be crushed and the maximum height of the mechanical arm and raises the lifting platform according to the difference value, such that the mechanical arm is capable of reaching the predetermined height and the mechanical arm is controlled to be adjusted to the predetermined height and the predetermined attitude.

8. The vehicle-mounted high-energy laser-induced rock fracturing control system according to claim 7, wherein the laser emission parameter corresponding to the type of the rock to be crushed comprises laser spot size, laser irradiation power and laser irradiation time; and
the adjusting the laser emission parameter refers to:
acquiring image information of laser-induced rock fracturing via the first image acquisition and analysis unit, acquiring crack area information, opening degree information and length information based on the image information, and taking the crack area information, opening degree information and length information as the real-time condition information; and
in a laser irradiation process at the position of the current rock to be crushed, determining whether the type of the rock changes in real time, wherein if the type of the rock does not change, determining whether the crack area information, opening degree information and length information correspond to the predetermined crack area information, predetermined opening degree information and predetermined length information, and if the crack area information, opening degree information, and length information do not correspond to the predetermined crack area information, predetermined opening degree information, and predetermined length information, instructing the laser control unit to linearly increase or decrease the laser spot size, the laser irradiation power and the laser irradiation time until the crack area information, the opening degree information and the length information correspond to the predetermined crack area information, predetermined opening degree information and predetermined length information.

9. The vehicle-mounted high-energy laser-induced rock fracturing control system according to claim 5, wherein in the laser irradiation process at the position of the current rock to be crushed, if the type of the rock remains unchanged, after the laser irradiation time reaches a predetermined time or it is determined that the rock reaches a predetermined rock fracturing state based on the crack area information, the opening degree information and the length information, the first image acquisition and analysis unit notifies the laser control unit to be shut down and notifies the mechanical arm control unit to adjust the mechanical arm to the next position of the rock to be crushed; and
in the laser irradiation process at the position of the current rock to be crushed, if the type of the rock is changed, the image information of the changed rock is sent to a remote management control center, and the remote management control center determines whether the laser irradiation process at the position of the current rock to be crushed is to be continued.

10. A vehicle-mounted high-energy laser-induced rock fracturing control method, applied to the vehicle-mounted high-energy laser-induced rock fracturing control system according to claim 1, comprising the following steps:
disposing the electric flat cart control unit, the laser control unit, the first image acquisition and analysis unit and the second image acquisition and analysis unit on the electric flat cart, and disposing the laser emission unit on the electric flat cart via the mechanical arm;
acquiring, by the second image acquisition and analysis unit, the surrounding environment information in the moving process of the electric flat cart, and sending the surrounding environment information to the electric flat cart control unit;
generating, by the electric flat cart control unit, the first control command according to the stored motion path of the electric flat cart and the surrounding environment information acquired by the second image acquisition and analysis unit;
after receiving the first control command of the electric flat cart control unit, controlling the electric flat cart to move to the designated rock crushing position;
after the electric flat cart moves to the designated rock crushing position, acquiring, by the first image acquisition and analysis unit, the type of the rock to be crushed, acquiring the real-time condition information of laser-induced rock fracturing after the laser emission unit is activated, and sending the real-time condition information to the laser control unit;
after receiving the type of the rock to be crushed acquired by the first image acquisition and analysis unit, acquiring, by the laser control unit, the laser emission parameter corresponding to the type of the current rock to be crushed, after receiving the real-time condition information of laser-induced rock fracturing acquired by the first image acquisition and analysis unit, adjusting the laser emission parameter, and generating the second control command according to the laser emission parameter; and
after receiving the second control command of the laser control unit, controlling the laser emission unit to activate to emit a laser to fracture the rock.
